(19) United States
(12) Patent Application Publication
(10) Pub. No.: US 2024/0301245 A1
(43) Pub. Date: Sep. 12, 2024

(54) PRESSURE-SENSITIVE ADHESIVE, PRESSURE-SENSITIVE ADHESIVE FILM AND PRESSURE-SENSITIVE TAPE

(71) Applicant: Lohmann GmbH & CO. KG, Neuwied (DE)

(72) Inventors: Vincent LEON, Koblenz (DE); Regina SCHULDAIS, Anhausen (DE); Daniel GÄRTNER, Koblenz (DE); Philipp RIES, Saffig (DE)

(21) Appl. No.: 18/596,209

(22) Filed: Mar. 5, 2024

(30) Foreign Application Priority Data
Mar. 7, 2023 (DE) 10 2023 000 859.1
Apr. 28, 2023 (DE) 10 2023 111 119.1

(51) Int. Cl. C09J 7/28; C09J 7/38; C09J 9/02

(52) U.S. Cl. CPC C09J 7/28; C09J 7/385; C09J 9/02; C09J 2301/124; C09J 2400/163; C09J 2433/00

(57) ABSTRACT

A pressure-sensitive adhesive for skin applications, having a polymer network comprising at least one copolymer and at least one type of electrically conductive particle to improve long-term bonding and efficiency. The copolymer may comprise 70 to 98.5% by weight of non-polar monomers and 1.5 to 30% by weight of polar monomers.

### CROSS-REFERENCE TO RELATED APPLICATIONS

The present application claims priority to German patent application DE 10 2023 111 119.1, “Haftklebstoff, Haftklebstoffschicht und Haftklebeband” (Pressure-sensitive adhesive, pressure-sensitive adhesive film and pressure-sensitive tape), filed Mar. 7, 2023.

### FIELD OF TECHNOLOGY

The present technology relates to a pressure-sensitive adhesive, a pressure-sensitive adhesive layer and a pressure-sensitive adhesive tape.

### BACKGROUND

The present invention relates to a pressure-sensitive adhesive, a pressure-sensitive adhesive layer and a pressure-sensitive adhesive tape.

The spectrum of applications for electrically conductive adhesives continually widens, which also increases the requirements placed on such adhesives. Because there is a rising desire for electronics capable of being worn on skin for long durations of time while, for example, measuring bio signals, there is a need for electrically conductive pressure-sensitive adhesives capable of providing a long-term bond both on uneven, low-energetic surfaces such as skin and even, high-energetic surfaces such as metals, and which ideally are also able to be removed without leaving any residue and without causing skin irritation.

Electrically conductive adhesives are, for example, known from WO 2020/178217 A1. The adhesive disclosed comprises an ionic liquid to provide sufficient electrical conductivity.

It is an object of the present technology to provide a generic pressure-sensitive adhesive with improved features relating to both a long-term bond and flexibility.

### BRIEF SUMMARY

The technology relates to a pressure-sensitive adhesive, in particular for skin applications, with a polymer network comprising at least one copolymer and at least one type of electrically conductive particles.

It is proposed that the copolymer comprises 70 to 98,5% by weight, or 85 to 96% by weight, or 90 to 95% by weight, of non-polar monomers and 1.5 to 30% by weight, or 3 to 15% by weight, or 5 to 10% by weight, of polar monomers. This way, a flexibility of the pressure-sensitive adhesive can be improved and its spectrum of applications can be widened. A careful adjustment of the polarity of the copolymer can optimize a breathability of the adhesive layer. Insufficient breathability leads to an accumulation of moisture between the pressure-sensitive adhesive and a surface on which the pressure-sensitive adhesive is applied, which reduces the long-time bonding of the pressure-sensitive adhesive and can cause skin irritation in skin applications. Excessive breathability leads to an accumulation of moisture inside of the pressure-sensitive adhesive, which also reduces the long-time bonding. Also, a pressure-sensitive adhesive with improved long-term bonding on surfaces exposed to moisture, such as window surfaces, building facade surfaces and/or skin surfaces, can be provided.

### BRIEF DESCRIPTION OF FIGURES

FIG. 1 A schematic depiction of a pressure-sensitive tape comprising a pressure-sensitive adhesive layer in a cross-sectional view.

### DESCRIPTION

A “pressure-sensitive adhesive layer” is to be understood as an adhesive layer which is permanently tacky at 25° C. and without a preceding activation step, for example a heating or an irradiation. The adhesive differs from structural adhesives configured to crosslink after an application, wherein the structural adhesives exhibit little to no tack before the crosslinking.

A “polymer network” is to be understood as a superordinate structure which consists of linked polymers. It could be imagined that the polymer network comprises a multitude of different copolymers. The polymer network may comprise exactly one type of copolymer. The copolymer may in particular be embodied as a random copolymer, a block copolymer or a homo polymer. For example, the copolymer could be embodied as a polyurethane copolymer, a synthetic-rubber copolymer, a natural-rubber copolymer, a silicone copolymer, an acrylonitrile-butadiene-styrene copolymer, a styrene-acrylonitrile copolymer or a styrene-ethylene-butylene-styrene copolymer.

The pressure-sensitive adhesive is biocompatible. The pressure-sensitive adhesive being “biocompatible” is to be understood as the pressure-sensitive adhesive fulfilling the requirements of normed tests for the biocompatibility of substances. The normed tests are dependent on a country of application of the pressure-sensitive adhesive, also, the pressure-sensitive adhesive at least fulfills the requirements of a test for skin irritation according to ISO 10993-10, a test for skin sensitization according to ISO 10993-10 and a test for cytotoxicity according to ISO 10993-5.

The pressure-sensitive adhesive may in particular comprise any electrically conductive particles. “Electrically conductive particles” are to be understood as objects with an average diameter on a millimeter scale, micrometer scale or nanometer scale which comprise at least one electrically conductive material. The average diameter, which is also known as the “lateral size”, is a manufacturer specification defining the average particle size. “Electrically conductive materials” in this context are to be understood as all materials which exhibit an electrical conductivity of at least 10⁶ S/m at 25° C., in particular metals and carbon. It is possible that the electrically conductive particles consist entirely of electrically conductive materials. Alternatively, the electrically conductive particles could comprise a coating made of one or multiple electrically conductive materials. For example, the electrically conductive particles may consist out of an electrically conductive polymer such as PEDOT:PSS. Alternatively, the electrically conductive particles may comprise a plastic core, aluminum core or glass core, which is coated with copper, silver or other metals. The pressure-sensitive adhesive may exhibit an impedance of at most 50Ω at 10 Hz when measured vertically through a pressure-sensitive adhesive layer with a thickness of 10 to 100 μm at 25° C.

The given weight percentages relate to a share of the corresponding substance of the pressure-sensitive adhesive in a non-crosslinked state. In the non-crosslinked state, the pressure-sensitive adhesive forms a pressure-sensitive adhesive mass which is configured to be coated in order to form a pressure-sensitive adhesive layer and goes through a polymerization reaction either before or after the coating. In particular, the adhesive may, in addition to the substances forming the polymer network after the polymerization reaction, comprise further substances, for example initiators, crosslinkers, tackifiers, antioxidants, reactive diluents, fillers such as for example glass spheres or ceramic spheres, foaming agents and further additives which are known to persons of ordinary skill in the art. The adhesive comprises at least 90% by weight, or at least 95% by weight, of substances of the copolymer. Assigning a weight percentage relating to the copolymer is to be understood as the assigned substances forming a part of the copolymer after the polymerization reaction.

The phrasings “X to Y”, “at least X”, “at most X” in this context are to be understood as including the borders of the respective ranges.

A monomer being “polar” in this context is to be understood as the monomer comprising at least one polar group, for example an OH group. A monomer being “non-polar” in this context is to be understood as the monomer being devoid of polar groups. The copolymer may also essentially consist of the polar and non-polar monomers. “Essentially” in this context is to be understood as the copolymer being able to comprise further components, such as remains of an initiator, however, these further components embody less than 0.5% by weight, or less than 0.1% by weight of the copolymer and do not affect the properties of the copolymer significantly.

Optimization of a property of the copolymer via a specific selection of monomers is to be understood as the copolymer, which is created via a polymerization reaction, exhibiting different properties than a comparable copolymer which is created via the same polymerization reaction but comprises different monomers or a different distribution of the same monomers. The polymerization reaction being the same is to be understood as a number of monomer units which are linked during the polymerization reaction to form the polymer, being identical for both polymerization reactions. For example, a copolymer formed out of short-chain monomers is by nature lighter than a copolymer formed out of long-chain monomers. This may be useful in industrial scale manufacturing processes, since the facilities used in these processes place certain requirements on the polymerization reaction, in particular concerning the reaction speed, by which an adjustment of the properties of the created copolymers via an adjustment of the polymerization reaction is often not possible.

In order to improve upon an efficiency of the pressure-sensitive adhesive, it is proposed that the electrically conductive particles provide the entirety of the electrical conductivity of the pressure-sensitive adhesive. In particular, the pressure-sensitive adhesive is devoid of ionic liquids or embedded electrically conductive structures which differ from the electrically conductive particles. This way, a manufacturing efficiency can be increased by omitting ionic liquids. The addition of different substances in order to provide an electrical conductivity can be omitted. The omission of any electrically conductive materials with the exception of the electrically conductive particles is based on the unexpected revelation that while the long-term bonding is negatively affected above a certain threshold amount of electrically conductive particles, tests have shown that below this threshold amount, the electrical conductivity provided by the electrically conductive particles is still sufficient for many fields of application.

It could be imagined that the copolymer is devoid of acids and instead exclusively comprises other types of polar monomers such as for example 2-hydroxyethyl acrylate. In order to further improve a long-term bonding of the pressure-sensitive adhesive, it is proposed that the copolymer comprises 0.1 to 10% by weight, or 3 to 7% by weight of acids. This way, a glass transition temperature of the copolymer can be optimized. The generally high glass transition temperature of acids, such as acrylic acid for example which has a glass transition temperature of 100.85° C., can be used to adjust the glass transition temperature of the copolymer towards a higher temperature. Also, through adjusting the glass transition temperature of the copolymer, a tackiness and a cohesion of the pressure-sensitive adhesive can be optimized, by which a premature debonding of the pressure-sensitive adhesive from a surface on which the pressure-sensitive adhesive is applied due to a cohesive failure and a presence of leftover residue after a removal of the pressure-sensitive adhesive can be prevented. Excessive cohesion of the adhesive layer leads to an insufficient wetting of uneven and/or low-energetic surfaces. Insufficient cohesion of the adhesive layer leads to an insufficiently strong bond leading to partial to complete debonding of the adhesive connection, furthermore, an insufficient cohesion of the adhesive layer may lead to leftover residue after a removal of the pressure-sensitive adhesive.

Furthermore, it is proposed that the copolymer comprises at least 50% by weight, or at least 70% by weight, or at least 90% by weight of acid esters whose molar masses are at least 100 g/mol, or at least 120 g/mol. For example, the acid esters may comprise n-butyl acrylate, 2-ethylhexyl acrylate, isobutyl acrylate, ethyl acrylate and/or propyl acrylate. This way, an average molar mass distribution of the copolymer can be optimized. An average molar mass distribution of the copolymer is 450.000 to 900.000 g/mol, or 500.000 to 800.000 g/mol and especially preferred 600.000 to 700.000 g/mol. Also, the cohesion and viscosity of the pressure-sensitive adhesive can be optimized via the adjustment of the average molar mass distribution of the copolymer. In addition, a manufacturing efficiency of the pressure-sensitive adhesive can be improved upon, in particular, the pressure-sensitive adhesive may be coated with generic coating processes such as for example curtain coating, blade coating or screen coating in order to form a pressure-sensitive adhesive layer. It could also be imagined that the pressure-sensitive adhesive is applied via ink jet printing processes or 3D printing processes.

In order to improve upon a long-term bonding of the pressure-sensitive adhesive, it is proposed that the copolymer is embodied as an acrylate copolymer. In particular, the monomers are embodied as acrylate monomers. The terms “acrylate copolymer” and “acrylate monomer” are to be understood as encompassing both pure acrylate copolymers and acrylate monomers as well as methacrylate copolymers and methacrylate monomers. In particular, any acrylate monomers known from the state of the art may be used, for example acrylic acid, methacrylate, ethyl acrylate, n-butyl acrylate, iso-butyl acrylate, tert-butyl acrylate, 2-ethylhexyl acrylate, 2-hydroxypropyl acrylate, 2-hydroxyethyl acrylate, iso-bornyl acrylate, N,N-dimethylaminoethyl acrylate, lauryl acrylate, stearyl acrylate, benzyl acrylate, methacrylic acid, methyl methacrylate, ethyl methacrylate, isopropyl acrylate, n-butyl methacrylate, iso-butyl methacrylate, tert-butyl methacrylate and/or cyclohexyl methacrylate. The acid may be embodied as acrylic acid. Acrylic acid may be the sole polar acrylate monomer of the acrylate copolymer. This way, a long-term bonding of the pressure-sensitive adhesive may be improved upon, in particular for skin applications. Tests have revealed that acrylate-based pressure-sensitive adhesives are ideal for long-term applications on skin surfaces due to being biocompatible, having a sufficient amount of breathability and being removable pain-free and without leaving residues.

In addition, it is proposed that a weight percentage of the electrically conductive particles is 5 to 30% by weight, or 10 to 25% by weight, or 15 to 20% by weight. Tests have revealed that the addition of electrically conductive particles in the amount stated provides a sufficient electrical conductivity without negatively affecting the long-time bonding of the pressure-sensitive adhesive.

It could be imagined that the electrically conductive particles are embodied as metal particles or metal-coated particles. In order to further improve upon a design of the pressure-sensitive adhesive, it is proposed that the electrically conductive particles are embodied as carbon particles. In particular, the electrically conductive particles may be embodied as graphite particles or graphene particles. This way, a sufficient electrical conductivity of the pressure-sensitive adhesive may be realized while keeping the amount of added electrically conductive particles low. Tests have revealed that electrically conductive particles comprising metals either do not provide a sufficient electrical conductivity or have to be added in large amounts that negatively affect the long-time bonding of the pressure-sensitive adhesive. Only carbon particles were able to enable the manufacturing of a pressure-sensitive adhesive providing an impedance of at most 50Ω at 10 Hz when measured vertically through a pressure-sensitive adhesive layer with a thickness of 10 to 100 μm at 25° C. as well as long-term bonding on skin surfaces for over 24 hours without any debonding or skin irritations.

Generally, the electrically conductive particles may have any shape and size, for example, they may be shaped like spheres, rods or be amorphous. In order to further improve upon a design of the pressure-sensitive adhesive, it is proposed that the electrically conductive particles are embodied as micro-platelets. “Micro-platelets” are to be understood as layered particles with an average diameter of at least 1 μm, and also at least 3 μm, and at most 20 μm, and also at most 10 μm. A thickness of the micro-platelets is at least 1 nm, or at least 5 nm, and, in addition, at most 500 nm, and also at most 250 nm. This way, a sufficient electrical conductivity, biocompatibility and long-term bonding of the pressure-sensitive adhesive can be achieved. The low thickness and large surface area of the micro-platelets provides a high contribution to the electrical conductivity of the adhesive layer for each electrically conductive particle, which allows for a reduction of the amount of electrically conductive particles which have to be added. The nanoparticles which have a diameter on the nanometer scale in any direction and are thus able to enter human cells can be omitted.

Furthermore, it is proposed that a glass transition temperature of the pressure-sensitive adhesive is −50 to −20° C. Tests have revealed that a pressure-sensitive adhesive having a glass transition temperature within the proposed range achieves optimal properties regarding a cohesion. The pressure-sensitive adhesive may also have a storage module of at least 0.1 MPa and therefore fulfils the Dahlquist criterion. This way, a sufficient wetting of uneven surfaces via the pressure-sensitive adhesive can be achieved and a long-time bonding can be improved.

It could be imagined that the pressure-sensitive adhesive comprises more than 10% by weight of crosslinkers in order to optimize a cohesion of the pressure-sensitive adhesive. In order to further improve upon a long-term bonding of the pressure-sensitive adhesive, it is proposed that the pressure-sensitive adhesive comprises 0.01 to 10% by weight, or 0.1 to 5% by weight, or 0.15 to 1% by weight of crosslinkers. A “crosslinker” is to be understood as a substance configured to link individual copolymers after the polymerization reaction in order to form the polymer network. In particular, crosslinkers differ from “curing agents” which are configured to link the monomers during the polymerization reaction in order to form the copolymer. The crosslinkers may in particular be any known crosslinkers for acrylate adhesives, such as for example ethylenglycol diacrylate, N,N′-methylenebisacrylamide or aluminum acetylacetonate. It could be imagined that the pressure-sensitive adhesive comprises multiple different types of crosslinkers. The pressure-sensitive adhesive comprises exactly one type of crosslinker. This way, a long-term bonding of the pressure-sensitive adhesive can be improved upon. Adjusting the cohesion via the glass transition temperature and the average molar mass distribution of the copolymer removes the need to adjust the cohesion via the addition of crosslinkers. Also, an adhesion of the pressure-sensitive adhesive can be improved upon via a reduction of the required amount of crosslinkers, since crosslinkers reduce the number of free copolymer chains which contribute to creating a pressure-sensitive bond.

In order to further improve upon a flexibility of the pressure-sensitive adhesive, it is proposed that the pressure-sensitive adhesive has an adhesive force on metal according to DIN EN 1939 (December 2003) of at least 10 N/25 mm, or at least 15 N/25 mm and or at least 25 N/25 mm and an adhesive force on skin according to DIN EN 1939 (December 2003) of at least 1 N/25 mm, or at least 2 N/25 mm or at least 5 N/25 mm. In this way, a pressure-sensitive adhesive can be achieved with is suitable for any type of skin application.

The adhesive force according to DIN EN 1939 (December 2003) is defined as the force required to remove an adhesive strip from a specific substrate, at a specific angle and at a specific speed. Measurement of the adhesive force according to DIN EN 1939 (December 2003) is performed as follows: A sample layer of the pressure-sensitive adhesive with a width of 25 mm and a length of 100 mm is manufactured. Afterwards the sample is applied on a substrate, resulting in a bonded surface of 625 mm². For the measurement of the adhesive force on metal, the substrate consists of steel, for the measurement of the adhesive force on skin, the substrate is meant to emulate human skin and may consist of a polyurethane leather or an artificial skin. On a side of the sample opposite to the substrate, a roughly 10 cm long strip of a 50 μm thick PET foil is applied. Afterwards, the sample is pressed to the substrate using a 5 kg roller in order to ensure a complete bonding. After 10 minutes, the sample is removed from the substrate at a speed of 300 mm/min and at an angle of 180°, wherein the force required to completely remove the sample is measured. The median of five measurements then defines the adhesive force in N/25 mm. The measurement is made under standard conditions which are defined as a temperature of 23° C.±2° C. and a humidity of 50%±5%.

In a further aspect of the invention, a pressure-sensitive adhesive layer comprising the pressure-sensitive adhesive with a thickness of 10 to 100 μm, or 20 to 80 μm, or 30 to 60 μm, may be used. For example, the pressure-sensitive adhesive layer may be embodied as part of a transfer tape. The transfer tape comprises the pressure-sensitive adhesive layer and one or two release liners. In the case of the transfer tape comprising only one release liner, the transfer tape may also be embodied as a wound transfer tape. In the case of the transfer tape comprising two release liners, the release liners are may also be applied on opposite sides of the pressure-sensitive adhesive layer. This way, a pressure-sensitive adhesive layer with improved properties regarding a long-term bonding and a flexibility can be achieved. Tests have revealed that a thickness of the pressure-sensitive adhesive layer within the proposed range achieves optimal properties regarding an electrical conductivity and a long-term bonding. Insufficient thickness of the pressure-sensitive adhesive layer leads to easy tearing, which makes the pressure-sensitive adhesive layer hard to process and does not allow for a sturdy bonding. Excessive thickness of the pressure-sensitive adhesive layer leads to high material costs both regarding the pressure-sensitive adhesive as well as regarding the electrically conductive particles, and due to the high thickness, there is a high likelihood of cohesive failure, furthermore, the amount of electrically conductive particles which would have to be added would be so high that a long-term bonding of the pressure-sensitive adhesive layer would be negatively affected.

In a further aspect of the invention, a pressure-sensitive adhesive tape comprising one or two of the pressure-sensitive adhesive layers and an electrically conductive carrier is proposed. It is possible that the electrically conductive carrier is embodied as a textile and consists of metal fibers, coated glass fibers, coated plastic fibers and/or electrically conductive polymer fibers. The electrically conductive carrier may also be devoid of recesses and can be embodied as, for example, a metal foil, an electrically conductive polymer foil or a carbon foil. This way, a one-sided or double-sided pressure-sensitive tape with improved properties regarding a long-term bonding and a flexibility can be achieved.

Additional aspects are disclosed in the following description of the figure.

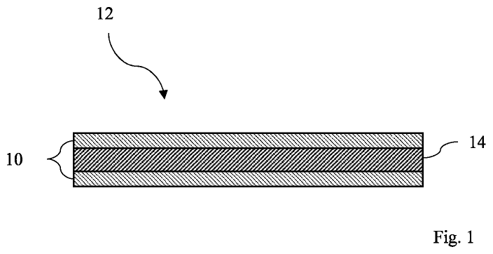

FIG. 1 shows a pressure-sensitive tape 12. The pressure-sensitive tape 12 is embodied as a double-sided tape. Alternatively, the pressure-sensitive tape 12 could also be embodied as a one-sided tape. The pressure-sensitive adhesive tape 12 comprises two pressure-sensitive adhesive layers 10. The pressure-sensitive adhesive layers 10 are identical to each other, which is why in the following, only one of the pressure-sensitive adhesive layers 10 will be discussed. Alternatively, the pressure-sensitive adhesive layers 10 could be different to each other.

The pressure-sensitive adhesive tape 12 comprises an electrically conductive carrier 14. The electrically conductive carrier 14 is embodied as an aluminum foil. Alternatively, the electrically conductive carrier 14 could also be embodied as a foil made of another metal, an electrically conductive polymer, a carbon, or a textile made of electrically conductive fibers.

The pressure-sensitive adhesive layer 10 has a thickness of 30 μm. The pressure-sensitive adhesive layer 10 comprises a pressure-sensitive adhesive. The pressure-sensitive adhesive layer 10 is anisotropically electrically conductive.

The pressure-sensitive adhesive comprises a polymer network. The polymer network comprises an acrylate copolymer. Alternatively, the pressure-sensitive adhesive could comprise a polyurethane copolymer, a rubber copolymer and/or a silicone copolymer. The acrylate copolymer comprises 95% by weight of non-polar acrylate monomers and 5% by weight of polar acrylate monomers. The acrylate copolymer comprises 95% by weight of acrylic acid esters with an average molar mass of at least 100 g/mol. An average molar mass of the acrylate copolymer is 650.000 g/mol.

The pressure-sensitive adhesive comprises 17,5% by weight of electrically conductive particles. The electrically conductive particles provide the entirety of the electrical conductivity of the pressure-sensitive adhesive. The pressure-sensitive adhesive is devoid of ionic liquids. The electrically conductive particles are embodied as graphene micro-platelets. It could also be imagined that the electrically conductive particles are embodied as metal micro-platelets or carbon micro-spheres. The graphene micro-platelets have an average diameter of 5 μm and a thickness of below 50 nm according to the manufacturer specifications.

The pressure-sensitive adhesive has an adhesive force on metal according to DIN EN 1939 (December 2003) of at least 10 N/25 mm adhesive force on skin according to DIN EN 1939 (December 2003) of at least 1 N/25 mm. A glass transition temperature of the pressure-sensitive adhesive is −47° C. The pressure-sensitive adhesive comprises 0.2% by weight of crosslinkers and 99.8% by weight of substances of the acrylate copolymer. The following table shows a composition of the pressure-sensitive adhesive:

| Substance | Function | Weight percentage | |
|---|---|---|---|
| N-butyl acrylate | Non-polar acrylate | 39.9% | by weight |
| | monomer | | |
| 2-ethylhexyl acrylate | Non-polar acrylate | 54.9% | by weight |
| | monomer | | |
| Acrylic acid | Polar acrylate monomer | 5% | by weight |
| Aluminum | Crosslinker | 0.2% | by weight |
| acetylacetonate | | | |

1. A pressure-sensitive adhesive for skin applications, with a polymer network comprising at least one copolymer and at least one type of electrically conductive particles, characterized in that the copolymer comprises 70 to 98.5% by weight of non-polar monomers and 1.5 to 30% by weight of polar monomers.

2. The pressure-sensitive adhesive of claim 1, wherein the electrically conductive particles provide all electrical conductivity of the pressure-sensitive adhesive.

3. The pressure-sensitive adhesive of claim 1 wherein the copolymer comprises 0.1 to 10% by weight of acrylic acid.

4. The pressure-sensitive adhesive of claim 1, wherein the copolymer comprises at least 50% by weight of acid esters and molar masses are at least 100 g/mol.

5. The pressure-sensitive adhesive of claim 1, wherein the copolymer is an acrylate copolymer.

6. The pressure-sensitive adhesive of claim 1, wherein a weight percentage of the electrically conductive particles is 5 to 30% by weight.

7. The pressure-sensitive adhesive of claim 1, wherein the electrically conductive particles are carbon particles.

8. The pressure-sensitive adhesive of claim 1, wherein the electrically conductive particles are micro-platelets.

9. The pressure-sensitive adhesive of claim 1, having a glass transition temperature of −50 to −20° C.

10. The pressure-sensitive adhesive of claim 1, having 0.01 to 10% by weight of a crosslinker.

11. The pressure-sensitive adhesive of claim 1, having an adhesive force on metal of at least 10 N/25 mm and an adhesive force on skin of at least 1 N/25 mm.

12. A pressure-sensitive adhesive layer, comprising a pressure-sensitive adhesive of claim 1 having a thickness of 10 to 100 μm.

13. A pressure-sensitive adhesive tape, comprising one or two pressure-sensitive adhesive layers of claim 12 having an electrically conductive carrier.
